(19) United States
(12) Patent Application Publication
(10) Pub. No.: US 2006/0019684 A1
(43) Pub. Date: Jan. 26, 2006

(54) Short message filter mechanism and communication device

(76) Inventors: Xiao-Qin Yu, Shanghai (CN); Shih-Kuang Tsai, Shanghai (CN); Tai-Shui Ho, Shanghai (CN)

Correspondence Address: BIRCH STEWART KOLASCH & BIRCH, PO BOX 747, FALLS CHURCH, VA, 22040-0747, US

(21) Appl. No.: 10/896,119

(22) Filed: Jul. 22, 2004

(51) Int. Cl. H04Q 7/20

(52) U.S. Cl. 455/466; 455/412.1

(57) ABSTRACT

A communication device with a short message filter mechanism. The communication device comprises an incoming phone number filter module for acquiring the number of digits in an incoming phone number accompanying a short message received by the communication device and, if the number of digits in the incoming phone number is less than a preset value, deleting the short message, and a keyword filter module for determining whether the short message contains a specific keyword and, if so, deleting the short message.

### BACKGROUND

The present invention relates to a short message filter mechanism and a communication device utilizing the same.

Technology development has enabled a variety of means of communication, such as mobile phones. In addition to basic communication functions, mobile phones commonly provide a short message messaging function. Differed from basic voice communication, short message messaging enables data transmission in text format.

Mobile phone users, however, often receive unwanted junk short messages and must spend time to delete them. Additionally, annoying junk short messages can divert the user from other important messages.

### SUMMARY

Accordingly, embodiments of the invention provide a short message filter mechanism employed in a communication device for filtering short messages received thereby. The method of the mechanism comprises the steps of acquiring the number of digits in an incoming phone number accompanying the short message received by the communication device, determining whether the number of digits in the incoming phone number is less than a preset value, deleting the short message if the number of digits in the incoming phone number is less than a preset value, comparing all keywords in a keyword set with the short message to determine whether the short message contains any keyword in the keyword set, and deleting the short message if the short message contains any keyword in the keyword set.

Embodiments of the invention further provide a communication device with a short message filter mechanism, comprising an incoming phone number filter module for acquiring the number of digits in an incoming phone number accompanying a short message received by the communication device and, if the number of digits in the incoming phone number is less than a preset value, deleting the short message, and a keyword filter module for determining whether the short message contains a specific keyword and, if so, delete the short message.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram of a mobile phone with a short message filter mechanism according to an embodiment of the invention.

FIGS. 2a-2g are diagrams showing text options on a screen of the mobile phone when the short message filter mechanism is executed.

FIG. 3 is a diagram showing the mobile phone of an embodiment of the invention connected to a personal computer.

FIG. 4 is a flowchart of processes in the short message filter mechanism.

### DETAILED DESCRIPTION

A primary aim of the invention is to preset the number of digits and define a keyword set used and filter short messages accordingly, thus deleting junk short messages to ensure quality of received short messages.

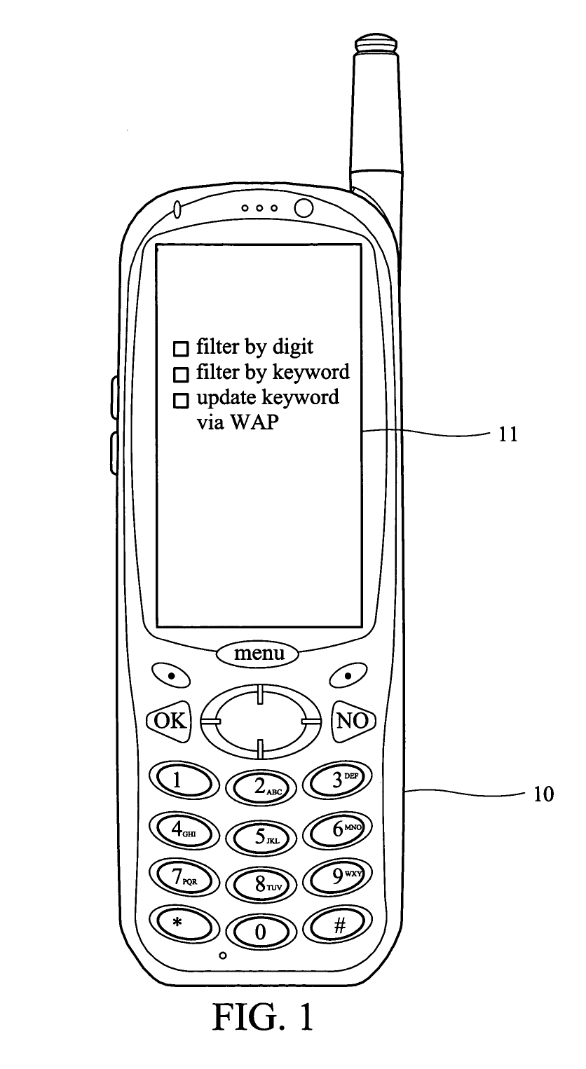

FIG. 1 is a diagram of a mobile phone 10 with a short message filter mechanism according to an embodiment of the invention. Based on the number of digits in an incoming phone number or a keyword set, the short message filter mechanism (not shown in the drawings) of the mobile phone 10 selectively filters short messages received from an outside source or pre-stored in the mobile phone 10. The mobile phone 10 comprises an incoming phone number filter module (not shown in the drawings), a keyword filter module (not shown in the drawings), and a keyword update module (not shown in the drawings). These modules can be implemented by either electronic circuitry or software.

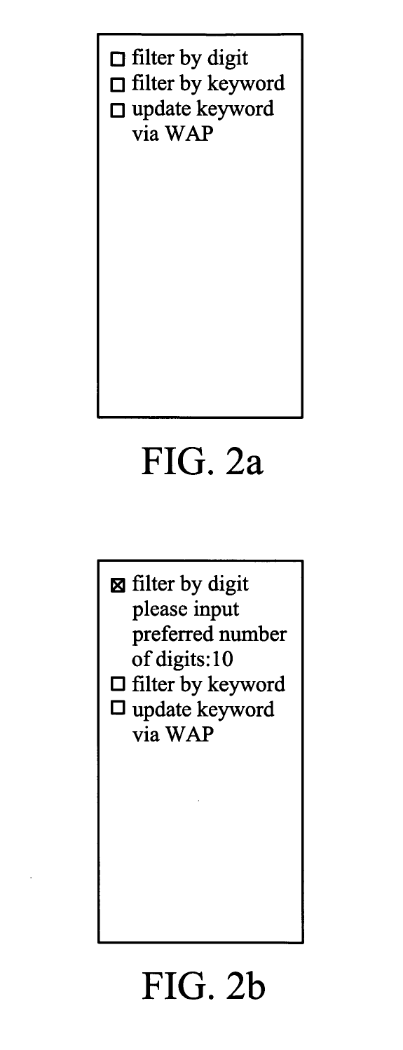

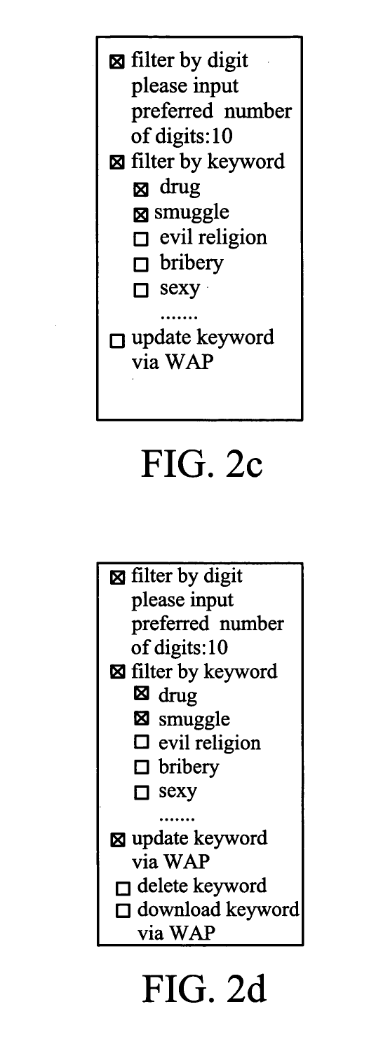

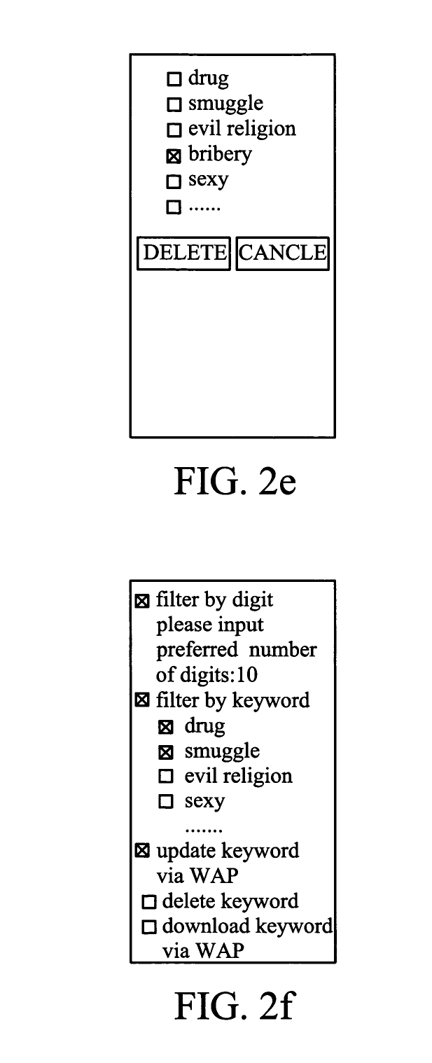

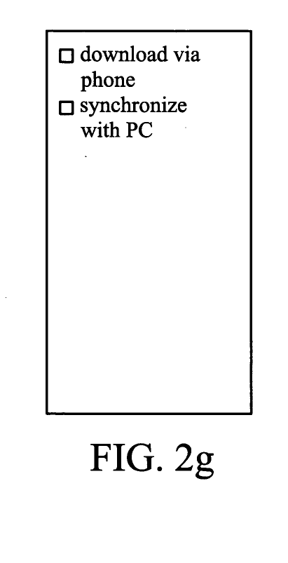

FIGS. 2a-2g are diagrams showing text options on a screen 11 of the mobile phone when the short message filter mechanism is executed. FIG. 2a shows text options on the screen 11 of the mobile phone when the short message filter mechanism is activated. As shown in FIG. 2b, when a user activates the option “filter by digit”, an input cursor is shown immediately following the “please input preferred number of digits:” prompt. A preferred number of digits is then input as a preset value, for example, “10” in FIG. 2b. Next, the incoming phone number filter module acquires the number of digits in an incoming phone number accompanying a short message received by the mobile phone and determines whether the number of digits in the incoming phone number is less than the preset value “10”. If so, the incoming phone number filter module deletes the short message, thereby all short messages with an incoming phone number of which the number of digits is less than 10 will not be shown on the screen 11.

If the number of digits in the incoming phone number is greater than 10, the short message filter mechanism proceeds to the next process thereof. The short message filter mechanism contains a keyword set including several common keywords selectable by the user. As shown in FIG. 2c, when the user activates the option “filter by keyword”, all keywords in the keyword set pre-stored in the mobile phone 10 are shown on the screen 11 for user selection, for example, “drug”, “smuggle”, “evil religion”, “bribery”, and so on in FIG. 2c. Therefore, the user selects desired keywords, for example, “drug” and “smuggle” in FIG. 2c. Then, the keyword filter module compares “drug” and “smuggle” with the short message to determine whether the short message contains “drug” or “smuggle”. If so, the keyword filter module deletes the short message, otherwise the short message is determined acceptable for display on the screen 11 for the user.

Additionally, useless keywords in the keyword set can be deleted via the keyword update module. As shown in FIG. 2d, when the user activates the option “update keyword via WAP”, the two options therebelow “delete keyword” and “download keyword via WAP” are shown on the screen 11. As shown in FIG. 2e, when the user activates the option “delete keyword”, all keywords in the keyword set are shown on the screen 10 for the user to select. As shown in FIG. 2e, the user selects “bribery”. If the user clicks “CANCEL” button, the short message filter mechanism returns to the previous process thereof, and the keyword “bribery” remains undeleted. If the user clicks the “DELETE” button, the keyword “bribery” is then deleted, as shown in FIG. 2f.

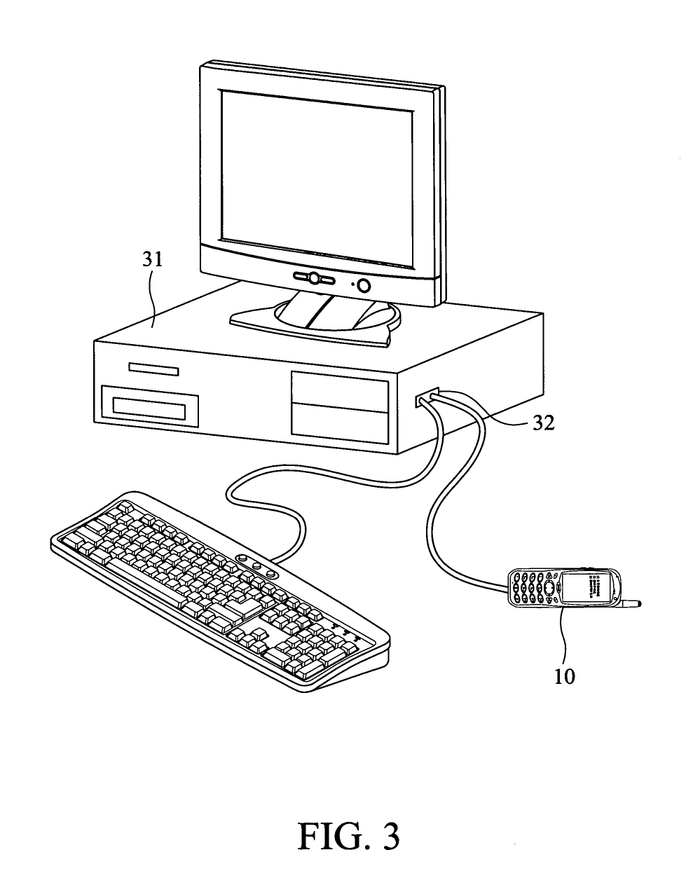

The user can also add new useless keywords into the keyword set via the keyword update module. The keyword update module updates the keywords when the mobile phone 10 communicates wirelessly with an outside source via Wireless Application Protocol (WAP). As shown in FIG. 2g, when the user activates the option “download keyword via WAP”, the two options therebelow “download via phone” and “synchronize with PC” are shown on the screen 11. When the user activates the option “download via phone”, the user downloads desired keywords wirelessly via Wireless Application Protocol (WAP). Alternatively, as shown in FIG. 3, the mobile phone 10 is connected with a personal computer (PC) 31 via a universal serial bus (USB) interface 32, thereby when the user activates the option “synchronize with PC” (FIG. 2g), the mobile phone 10 synchronizes with the PC 31 to acquire keywords previously downloaded and stored in the PC 31.

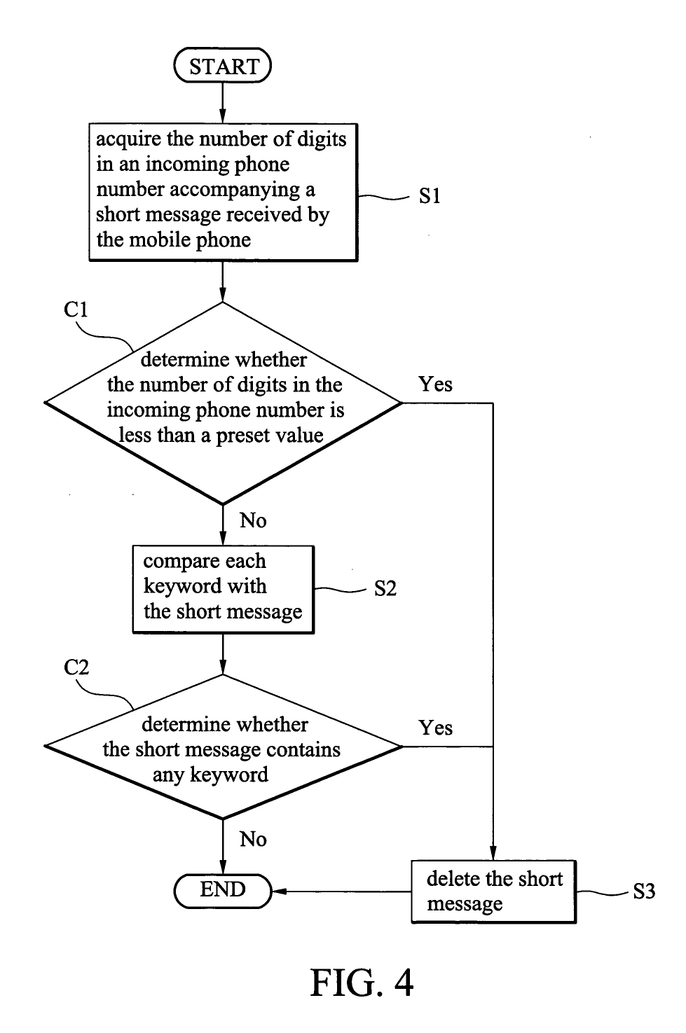

FIG. 4 is a flowchart of processes in the short message filter mechanism. Please refer to the embodiment and the accompanying drawings described hereinbefore. First, in step S1, the short message filter mechanism acquires the number of digits in an incoming phone number accompanying a short message received from an outside source by the mobile phone 10 or pre-stored in the mobile phone 10. In conditional C1, the short message filter mechanism determines whether the number of digits in the incoming phone number is less than a preset value, for example, “10” in FIG. 2b. If so, in step S3, the short message filter mechanism deletes the short message, otherwise in step S2, the short message filter mechanism compares each keyword selected by the user, for example, “drug” and “smuggle” in FIG. 2c, with the short message. Then in conditional C2, the short message filter mechanism determines whether the short message contains any keyword selected by the user, for example, “drug” and “smuggle” in FIG. 2c. If so, in step S3, the short message filter mechanism deletes the short message, otherwise the short message filter mechanism stops. The short message filter mechanism further comprises an update step (not shown in the drawings) for updating the keywords, such as deleting useless keywords or adding new keywords. In the update step, the user downloads desired keywords wirelessly via Wireless Application Protocol (WAP). Alternatively, as shown in FIG. 3, the mobile phone 10 is connected with a personal computer (PC) 31, thereby the mobile phone 10 synchronizes with the PC 31 to acquire keywords previously downloaded and stored in the PC 31.

Embodiments of the invention are capable of filtering short messages received from an outside source or pre-stored in a mobile phone based on the number of digits in an incoming phone number or a keyword set, thus deleting junk short messages to ensure quality of received short messages.

Additionally, the short message filter mechanism of the invention is capable of updating the keyword set, such as deleting or adding keywords in the keyword set, via WAP or by synchronizing with a PC, thus enhancing convenience.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device with a short message filter mechanism, comprising:
an incoming phone number filter module for acquiring the number of digits in an incoming phone number accompanying a short message received by the communication device and, if the number of digits in the incoming phone number is less than a preset value, deleting the short message; and
a keyword filter module for determining whether the short message contains a specific keyword and, if so, deleting the short message.

2. The communication device as claimed in claim 1 is a mobile phone.

3. The communication device as claimed in claim 1, wherein the short message is stored in the communication device.

4. The communication device as claimed in claim 1, wherein the short message is received by the communication device from an outside source.

5. The communication device as claimed in claim 1 further comprising a keyword update module for updating the specific keyword.

6. The communication device as claimed in claim 5, wherein the keyword update module updates the specific keyword when the communication device communicates wirelessly with an outside source via Wireless Application Protocol (WAP).

7. The communication device as claimed in claim 5, wherein the keyword update module updates the specific keyword when the communication device is connected to a processing device.

8. A short message filter mechanism applied in a communication device for filtering a short message received by the communication device, comprising the steps of:
acquiring the number of digits in an incoming phone number accompanying the short message received by the communication device;
determining whether the number of digits in the incoming phone number is less than a preset value;
deleting the short message if the number of digits in the incoming phone number is less than a preset value;
comparing all keywords in a keyword set with the short message to determine whether the short message contains any keyword in the keyword set; and
deleting the short message if the short message contains any keyword in the keyword set.

9. The short message filter mechanism as claimed in claim 8, wherein the communication device is a mobile phone.

10. The short message filter mechanism as claimed in claim 8, wherein the short message is stored in the communication device.

11. The short message filter mechanism as claimed in claim 8, wherein the short message is received by the communication device from an outside source.

12. The short message filter mechanism as claimed in claim 8 further comprising a step of updating the keyword set.

13. The short message filter mechanism as claimed in claim 12, wherein the step of updating the keyword set is executed when the communication device communicates wirelessly with the outside source via Wireless Application Protocol (WAP).

14. The short message filter mechanism as claimed in claim 12, wherein the step of updating the keyword set is executed when the communication device is connected with a processing device.
